(19) United States
(12) Patent Application Publication
(10) Pub. No.: US 2005/0206768 A1
(43) Pub. Date: Sep. 22, 2005

(54) Charge transfer device and drive method for same

(75) Inventor: Ryoichi Goto, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC Electronics Corporation, Kanagawa (JP)

(21) Appl. No.: 11/080,523

(22) Filed: Mar. 16, 2005

(30) Foreign Application Priority Data
Mar. 17, 2004 (JP) 2004-076430

(51) Int. Cl. H04N 3/14

(52) U.S. Cl. 348/323

(57) ABSTRACT

A charge transfer device according to the present invention comprises 4n (where n is a positive integer) initial-stage charge transfer registers to which a plurality of photoelectric converters is connected and a charge detection unit detecting a charge transferred from the initial-stage charge transfer registers in sequence via a secondary-stage charge transfer register. The merging of two charge transfer registers adjacent to each other among the initial-stage charge transfer registers into one charge transfer register disposed in the secondary stage is repeated at least once, and the final two charge transfer registers after merging are connected to one charge detection unit.

### BACKGROUND OF THE INVENTION

1. Field of the Invention

The present invention relates to a charge transfer device and to a drive method for the same.

2. Description of the Related Art

Progress in reduction of pixel size and increased resolution has been made in image sensors or charge transfer devices in recent years, and miniaturization in design rules is desired. However, the miniaturization of design rules requires resources and time, and instant adaptation to the demand for reduced pixel size is difficult. Because of this situation, various charge transfer systems have been developed for obtaining a high-resolution CCD without changing design rules.

FIG. 12 is a plan view-showing the structure of a single CCD-type charge transfer device.

The charge transfer device shown in FIG. 12 is provided with a photodiode row 2 in which photodiodes are arranged in a row at a prescribed pitch; a single Charge Coupled Device (CCD)1; and a read gate 10 provided between the CCD 1 and the photodiode row 2.

In FIG. 12, the arrows pointing towards the CCD 1 from the photodiodes contained in the photodiode row 2 indicate the read direction from each of the photodiodes to the CCD 1. In other words, the charges from the photodiodes are read to the CCD 1 via the read gate 10.

The CCD 1 is connected to the charge detection unit 4 via the output gate 3a. The CCD 1 is provided with a reset gate 5 that is adjacent to the charge detection unit 4. Furthermore, a drain 6 is provided adjacent to the reset gate 5, and the drain 6 is connected to the power supply line 8 from which a power supply potential is provided.

The charge detection unit 4 is connected to a source follower amplifier 7. This source follower amplifier 7 is provided with interconnected MOS transistors 12a and 12b. Among these components, the source of the MOS transistor 12a is connected to the power supply line 8, the gate thereof is connected to the charge detection unit 4, and the drain thereof is connected to the source of the MOS transistor 12b. The gate of the MOS transistor 12b is connected to the power supply line 8, and the drain thereof is connected to the (GND) line 9 from which a ground (GND) potential is supplied. Furthermore, the point at which the MOS transistors 12a and 12b are interconnected is connected to a signal output line 11.

Thus, the single CCD-type charge transfer device is provided with one CCD 1 for one photodiode row 2.

FIG. 13 is a plan view showing the structure of a dual-CCD charge transfer device.

In the charge transfer device shown in FIG. 13, the same symbols are used for structural elements that are the same as those in the charge transfer device shown in FIG. 12, and description thereof is omitted.

As shown in FIG. 13, CCD 1a and 1b are provided on both sides corresponding to a single photodiode row 2 in the dual-CCD charge transfer device.

Specifically, the photodiodes contained in the photodiode row 2 are in a staggered arrangement that alternates in sequence on the side of the CCD 1a or on the side of the CCD 1b, whereby each photodiode is connected to one of either the CCD 1a or the CCD 1b and sends a charge to the CCD it is connected to.

The CCD 1a and 1b merge at the output gate 3a, and are both connected to the charge detection unit 4.

Other aspects of the structure of the dual-CCD charge transfer device shown in FIG. 13 are the same as in the single CCD-type charge transfer device shown in FIG. 12.

In the dual-CCD system shown in FIG. 13, increased resolution is obtained by miniaturizing (reducing the dimensions in the arrangement direction) only the photodiodes contained in the photodiode row 2, while the design rules of the CCD 1a and 1b are kept unchanged.

A configuration has conventionally been adopted whereby a charge detection unit 4 is separately provided for each CCD 1a and 1b, and signal output lines 11 are independently provided in alternating fashion on the side of the CCD 1a and on the side of the CCD 1b, however in the case of this type of configuration, it is necessary for the output signals from the signal output lines 11 to be synthesized by an external circuit.

It is for this reason that a system was developed for receiving the charge delivered from the two CCD 1a and 1b using a single charge detection unit 4, as shown in FIG. 13, in order to eliminate the synthesis of output signals by an external circuit.

FIG. 14 is a plan view showing the structure of a charge transfer device having a staggered photodiode arrangement with a two-pixel structure.

In the charge transfer device shown in FIG. 14, the same symbols are used for structural elements that are the same as those in the charge transfer device shown in FIG. 13, and description thereof is omitted.

As shown in FIG. 14, the charge transfer device having a staggered photodiode arrangement with a two-pixel structure has two photodiode rows 2a and 2b arranged parallel to each other in alternating fashion, and CCD 1a and 1b corresponding to the photodiode rows 2a and 2b, respectively.

In this arrangement, the photodiodes contained in the photodiode row 2a and the photodiodes contained in the photodiode row 2b are arranged so as to be offset by a half pitch with respect to each other in their arrangement direction.

Other aspects of the structure of the charge transfer device having a staggered photodiode arrangement shown in FIG. 14 are the same as in the dual-CCD charge transfer device shown in FIG. 13.

In other words, the system shown in FIG. 14 is a method for obtaining a single output by aligning the two photodiode rows 2, CCD 1, and read gates 10 in the single-CCD system in mutually staggered fashion, and synthesizing the charges delivered from the two photodiode rows 2, CCD 1, and read gates 10 in the charge detection unit 4.

An example of design rules whereby a single-CCD system can be obtained having a photodiode pitch of 8 μm will be described to show what resolution is obtained by the systems shown in FIGS. 12 through 14. The aspect that causes resolution to be limited by the design rules is usually the design that is related to the electrode positioning of the CCD.

First, in a dual-CCD system (FIG. 13), by setting the photodiode dimensions to 4 μm, and, using each CCD 1a and 1b to transfer every other charge of the photodiodes to the two CCD 1a and 1b, twice the number of pixels can be included in the same pitch length with respect to an 8-μm single CCD system. In this dual CCD system, the electrode pitch of each CCD 1a and 1b can be designed to the same pitch as the 8-μm single system.

In the staggered photodiode arrangement with a two-pixel structure (FIG. 14), the dimension of the photodiodes is 8 μm, and the same number of pixels can be included in the same pitch length as in the dual CCD system (FIG. 13) in which the photodiode dimension is 4 μm. The merit of having a large photodiode dimension is that the dynamic range can be increased, specifically, that the S/N ratio can be increased.

FIG. 15 is a plan view showing the first example of the structure of a charge transfer device having a four pixel-structured staggered photodiode arrangement, and FIG. 16 is a plan view showing the second example of the structure thereof.

In the charge transfer devices shown in FIGS. 15 and 16, the same symbols are used for structural elements that are the same as those in the charge transfer devices shown in FIGS. 12 through 14, and description thereof is omitted.

The charge transfer device shown in FIG. 15 is provided with four photodiode rows 2a, 2b, 2c, and 2d arranged parallel to each other, and two CCD 1a and 1b.

Specifically, the photodiode rows 2a and 2b are arranged on both sides of the CCD 1a, and the photodiode rows 2c and 2d are arranged on both sides of the CCD 1b.

The photodiodes in the photodiode rows 2a through 2d are connected to the corresponding CCD (one of either the CCD 1a or the CCD 1b) via the read gates 10. Furthermore, among the photodiodes in the photodiode rows 2a through 2d, the terminals thereof that are on the opposite side from the terminal connected to the read gate 10 are connected to the corresponding charge evacuation means among the charge evacuation means 20a, 20b, and 20c. The photodiodes in the photodiode rows 2a and 2c that are positioned between the CCD 1a and the CCD 1b share a common connection to the charge evacuation means 20b.

In this arrangement, the photodiode rows 2a through 2d are arranged so as to be offset by a quarter pitch with respect to each other in their arrangement direction. Therefore, in the charge transfer device shown in FIG. 15, it becomes possible to obtain twice the resolution of the dual system (FIG. 13). However, signals must be read for each of the photodiode rows 2a through 2d separately in the case of the charge transfer device of FIG. 15.

Other aspects of the configuration of the charge transfer device having a four pixel-structured staggered photodiode arrangement shown in FIG. 15 are the same as those of the charge transfer device having a staggered photodiode arrangement with a two-pixel structure shown in FIG. 14.

The charge transfer device shown in FIG. 16 is provided with four photodiode rows 2a, 2b, 2c, and 2d arranged parallel to each other, and four CCD 1a, 1b, 1c, and 1d, each corresponding to one of the photodiode rows 2a through 2d, respectively.

The photodiodes in the photodiode rows 2a through 2d are connected to the corresponding CCD (one of the CCD 1a through 1d) via the read gates 10. Furthermore, among the photodiodes in the photodiode rows 2a through 2d, the terminals that are on the opposite side from the terminal connected to the read gate 10 are connected to the corresponding charge evacuation means among the charge evacuation means 20a, 20b. The photodiode rows 2a and 2b are positioned between the CCD 1a and the CCD 1b, and these photodiode rows 2a and 2b share a common connection to the charge evacuation means 20a. In the same manner, the photodiode rows 2c and 2d are positioned between the CCD 1c and the CCD 1d, and these photodiode rows 2c and 2d share a common connection to the charge evacuation means 20b.

In the case of the charge transfer device shown in FIG. 16, the CCD 1a and 1b are connected to the charge detection units 4 via the output gates 3a. Furthermore, a reset gate 5, a drain 6, a power supply line 8, a source follower amplifier 7, a ground line 9, and a signal output line 11 are provided on the side of the CCD 1a and on the side of the CCD 1b, in the same manner as in the charge transfer devices (FIGS. 12 through 15) described above.

The CCD 1c and 1d are also connected to a charge detection unit 4 via an output gate 3a. A reset gate 5, a drain 6, a power supply line 8, a source follower amplifier 7, a ground line 9, and a signal output line 11 are provided on the side of the CCD 1c and on the side of the CCD 1d, in the same manner as in the charge transfer devices (FIGS. 12 through 15) described above.

The signal output line 11 on the side of the CCD 1a and 1b, and the signal output line 11 on the side of the CCD 1c and 1d are connected to a signal switch 101, and the signal switch 101 is connected to a signal output line 102.

Also in the case of the charge transfer device shown in FIG. 16, the photodiode rows 2a through 2d are arranged so as to be offset by a quarter pitch with respect to each other in their arrangement direction, the same as in the case of FIG. 15. Therefore, in the charge transfer device shown in FIG. 16, it becomes possible to obtain twice the resolution of the dual system (FIG. 13), the same as in the case of FIG. 15. However, in the case of the charge transfer device of FIG. 16, there must be two outputs (signal output lines 11), and the outputs must be synthesized into a single output by the signal switch 101.

FIG. 17 is a plan view showing the structure of a 4-CCD, 1-output charge transfer device.

In the charge transfer device shown in FIG. 17, the same symbols are used for structural elements that are the same as those in the charge transfer devices shown in FIGS. 12 through 16, and description thereof is omitted.

The 4-CCD, 1-output charge transfer device shown in FIG. 17 was developed for obtaining the advantage of the good S/N ratio of a staggered-type device, the advantage of being able to obtain further increased resolution while maintaining the same design rules, and the advantage of being able to reduce the clock (pulse φ1, φ2) frequency for transfer by one-half or less.

As shown in FIG. 17, the 4-CCD, 1-output charge transfer device is provided with two photodiode rows 2a and 2b, and four CCD 1a, 1b, 1c, and 1d.

Specifically, in the case of the charge transfer device shown in FIG. 17, two of the CCD 1a through 1d are provided for each of the photodiode rows 2a and 2b. The four CCD 1a through 1d are also connected to one charge detection unit 4.

The photodiodes contained in the photodiode row 2a are in a staggered arrangement that alternates in sequence on the side of the CCD 1a or on the side of the CCD 1b, whereby each photodiode is connected to one of either the CCD 1a or the CCD 1b and sends a charge to the CCD it is connected to.

In the same manner, the photodiodes contained in the photodiode row 2b are in a staggered arrangement that alternates in sequence on the side of the CCD 1c or on the side of the CCD 1d, whereby each photodiode is connected to one of either the CCD 1c or the CCD 1d and sends a charge to the CCD it is connected to.

In this arrangement, the two photodiode rows 2a and 2b are arranged so as to be offset by half the photodiode pitch with respect to each other in their arrangement direction. By offsetting the photodiode rows by a half pitch in this manner, it becomes possible to obtain twice the resolution in a single photodiode row.

The charges (signal charges) transferred from the two photodiode rows 2a and 2b to each of the four CCD 1a through 1d are transferred to the charge detection unit 4 via the output gate 3c, the output gate 3d, and the output gate 3e in sequence, converted to signal voltages, and detected via the output circuit subsequent to the source follower amplifier 7.

Other examples of the conventional art are found in Japanese Unexamined Patent Publication Nos. 11-205532, 4-14842, and 64-14966, for example.

FIG. 18 is a partial magnified view showing the bottom portion the polysilicon electrode in the 4-CCD, 1-output charge transfer device (FIG. 17), and FIG. 19 is a partial magnified view showing the positioning of the polysilicon electrode in the 4-CCD, 1-output charge transfer device.

As shown in FIGS. 18 and 19, an N-well 22 (FIG. 18) is formed on one principal surface of the P-substrate not shown in the diagram, and a first polysilicon layer electrode 24 and a second polysilicon layer electrode 25 (both in FIG. 19) are formed via an insulating film (not shown) on the N-well 22 so as to be arranged in alternating fashion.

Boron is implanted in the gap of the first polysilicon layer electrode 24, and an N-negative well 26 is formed in the top layer portion of the N-well 22. The first polysilicon layer electrode 24 thereby becomes a storage electrode for accumulating a charge, and the second polysilicon layer electrode 25 becomes a barrier electrode.

The drain 6 adjacent to the reset gate 5 is also composed of an N+positive diffusion layer 27 (FIG. 18).

In general, decreased charge detection capacity is desired in order to enhance sensitivity in charge transfer devices, and the charge detection unit 4 is therefore made so as to have the smallest surface area possible. Since the charges from four CCD 1a through 1d are transferred to a single charge detection unit 4 having a small surface area, the channel width is inevitably narrowed (for example, the width in the CCD 1b and 1c is narrowed from width W1 to width W2), and differences in the length (the length in the orthogonal direction with respect to the width W1) of the transfer channel inevitably occur due to a lack of symmetry. The length of the transfer channel is an important parameter relating to the transfer speed, and as a result of differences occurring in the transfer channel length, drawbacks occur whereby the transfer efficiency fluctuates between the CCD 1a through 1d.

In FIG. 18, channel separation areas 15a through 15c (notch-shaped portions formed in the electrode) for preventing charge mixing in the CCD 1a through 1d extend up to the output gate 3d (see FIG. 19). If the channel separation areas 15a through 15c did not extend up to the output gate 3d, it would be possible for a portion of the charge at the bottom of the CCD 1b to spill over into the CCD 1a, 1c, and 1d through the output gate 3c, and for charge mixing to occur in cases in which, for example, a low-level pulse has been applied to the last electrode of the CCD 1b, and high-level pulses have been applied to the last electrodes of the CCD 1a, 1c, and 1d.

Since the channel separation area extends up to the output gate 3d, the channel width of the CCD 1b and the CCD 1c gradually narrows from width W1 to width W2 in the direction of transfer. Drawbacks therefore occur whereby the transfer efficiency of the two inside CCD 1b and 1c among the four CCD 1a through 1d declines in comparison with that of the two outside CCD 1a and 1d.

### SUMMARY OF THE INVENTION

According to one aspect of the present invention, there is provided a charge transfer device comprising 4n (where n is a positive integer) initial-stage charge transfer registers to which a plurality of photoelectric converters is connected, and a charge detection unit detecting a charge transferred from the initial-stage charge transfer registers in sequence via a secondary-stage charge transfer register. The merging of two charge transfer registers adjacent to each other among the initial-stage charge transfer registers into one charge transfer register disposed in the secondary stage is repeated at least once, and the final two charge transfer registers after merging are connected to one charge detection unit.

According to another aspect of the present invention, there is provided a charge transfer device comprising a plurality of initial-stage charge transfer registers, each being connected to a plurality of photoelectric converters, a secondary-stage charge transfer register coupled to at least two initial-stage charge transfer registers and a charge detection unit coupled to the secondary-stage charge transfer register.

According to another aspect of the present invention, there is provided a method for driving the charge transfer device, comprising transferring a charge by applying first and second two-phase pulses in an inverse relationship to each other to the charge transfer registers.

According to the present invention, narrowing can be performed gradually and with good symmetry during merging of the charge transfer registers, allowing fluctuations in transfer efficiency between charge transfer registers to be minimized, and a charge transfer device having good transfer efficiency to be obtained. It is possible to obtain a charge transfer device that is designed for preventing mixing of charges between charge transfer registers and occurrence of devoid of transfer degradation due to the pattern structure thereof.

### BRIEF DESCRIPTION OF THE DRAWINGS

The above and other objects, advantages and features of the present invention will be more apparent from the following description taken in conjunction with the accompanying drawings, in which:

FIG. 1 is a plan view showing the structure of the charge transfer device according to a first embodiment;

FIG. 2 is a magnified view of portion A of FIG. 1;

FIG. 3 is a magnified view of portion B of FIG. 1;

FIG. 4 is a magnified view of portion C of FIG. 1;

FIG. 5 is a cross-sectional view along line V-V of FIG. 2;

FIG. 6 is a cross-sectional view along line VI-VI of FIG. 4;

FIG. 7 is a time chart showing the operational timing in the case of the first embodiment;

FIG. 8 is a circuit diagram showing an example of the φ5 and φ6 timing generation circuits;

FIG. 9 is a partial magnified view showing the bottom portion of the polysilicon electrode in the charge transfer device of FIG. 1;

FIG. 10 is a partial magnified view showing the positioning of the polysilicon electrode in the charge transfer device of FIG. 1;

FIG. 11 is a cross-sectional view along-line V-V of FIG. 2 in the case of the charge transfer device according to a second embodiment;

FIG. 12 is a plan view showing the structure of a conventional single-CCD charge transfer device;

FIG. 13 is a plan view showing the structure of a conventional dual-CCD charge transfer device;

FIG. 14 is a plan view showing the structure of a staggered charge transfer device with a two-pixel structure;

FIG. 15 is a plan view showing the structure of a first example of a conventional staggered charge transfer device with a four-pixel structure;

FIG. 16 is a plan view showing the structure of a second example of a conventional staggered charge transfer device with a four-pixel structure;

FIG. 17 is a plan view showing the structure of a conventional 4-CCD, 1-output charge transfer device;

FIG. 18 is a partial magnified view showing the bottom portion of the polysilicon electrode in the charge transfer device of FIG. 17; and

FIG. 19 is a partial magnified view showing the positioning of the polysilicon electrode in the charge transfer device of FIG. 17.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

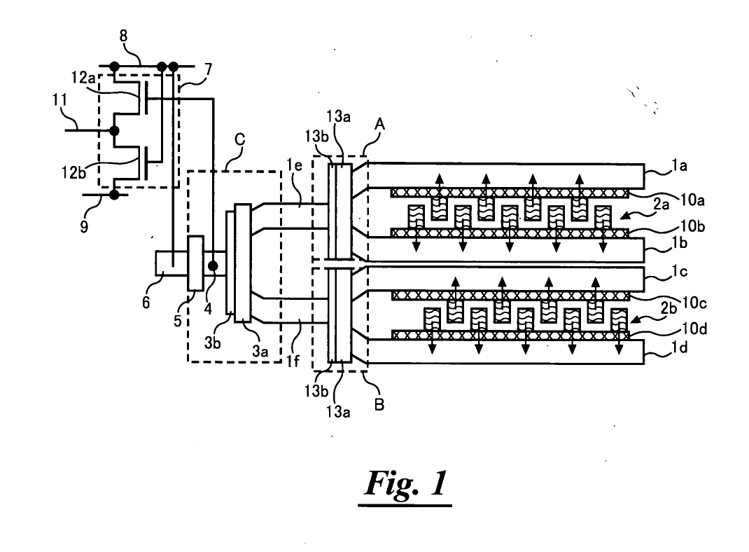

FIG. 1 is a plan view showing the structure of the charge transfer device according to the first embodiment.

As shown in FIG. 1, the charge transfer device according to the present invention embodiment has two photodiode rows 2a and 2b; four initial-stage CCD 1a, 1b, 1c, and 1d; and two secondary-stage CCD 1e and 1f.

The two CCD 1a and 1b are provided to the photodiode row 2a, and the two CCD 1c and id are provided to the photodiode row 2b.

The photodiode rows 2a and 2b are also each provided with a plurality of photodiodes (photoelectric converters) arranged at a prescribed pitch.

A read gate 10 is provided between the photodiodes contained in the photodiode rows 2a and 2b and the CCD 1a through 1d.

The photodiodes contained in the photodiode row 2a are in a staggered arrangement that alternates in sequence on the side of the CCD 1a or on the side of the CCD 1b, whereby each photodiode is connected via a read gate 10 to one of either the CCD 1a or the CCD 1b and sends a charge to the CCD it is connected to.

In the same manner, the photodiodes contained in the photodiode row 2b are in a staggered arrangement that alternates in sequence on the side of the CCD 1c or on the side of the CCD 1d, whereby each photodiode is connected via a read gate 10 to one of either the CCD 1c or the CCD 1d and sends a charge to the CCD it is connected to.

In this arrangement, the two photodiode rows 2a and 2b are arranged so as to be offset by half the photodiode pitch with respect to each other in their arrangement direction. By offsetting the photodiode rows by a half pitch in this manner, it becomes possible to obtain twice the resolution with respect to a single photodiode row.

The CCD 1a and 1b merge into the secondary CCD 1e (are connected to the CCE 1e) via the transfer gates 13a and 13b in portion A of FIG. 1.

In the same manner, the CCD 1c and 1d merge into the secondary CCD 1f via the transfer gates 13a and 13b in portion B of FIG. 1.

The CCD 1e and 1f are also connected to the charge detection unit 4 via the output gates 3a and 3b in portion C of FIG. 1.

This charge detection unit 4 is provided with a reset gate 5 adjacent thereto, a drain 6 is provided adjacent to the reset gate 5, and the drain 6 is connected to the power supply line 8 from which a power supply potential is supplied.

The charge detection unit 4 is also connected to the source follower amplifier 7.

This source follower amplifier 7 is provided with interconnected MOS transistors 12a and 12b. Among these components, the source of the MOS transistor 12a is connected to the power supply line 8, the gate thereof is connected to the charge detection unit 4, and the drain thereof is connected to the source of the MOS transistor 12b. The gate of the MOS transistor 12b is connected to the power supply line 8, and the drain thereof is connected to the (GND) line 9 from which a ground (GND) potential is supplied. Furthermore, the point at which the MOS transistors 12a and 12b are interconnected is connected to a signal output line 11.

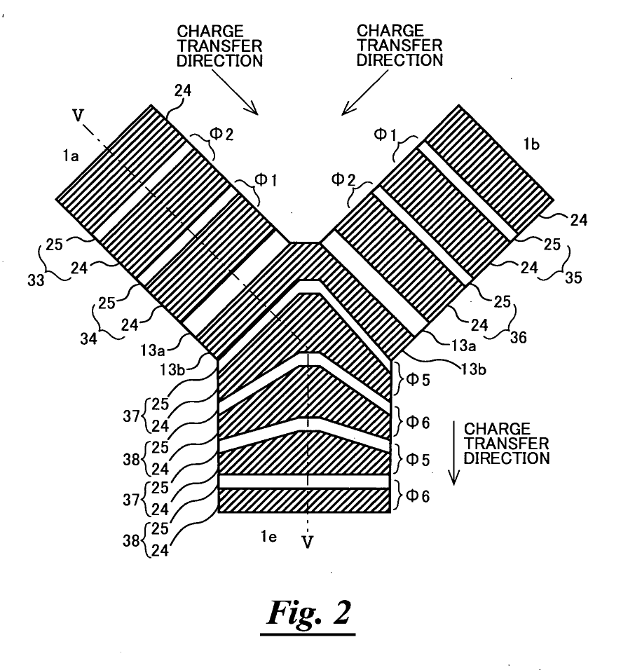

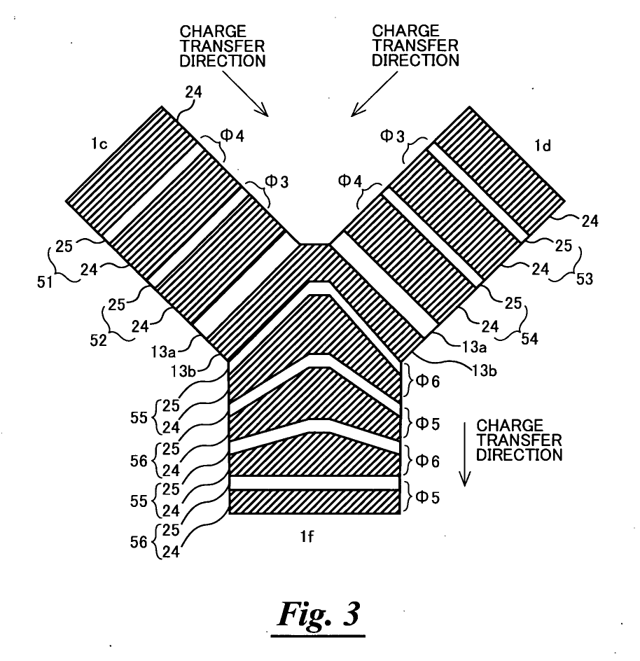

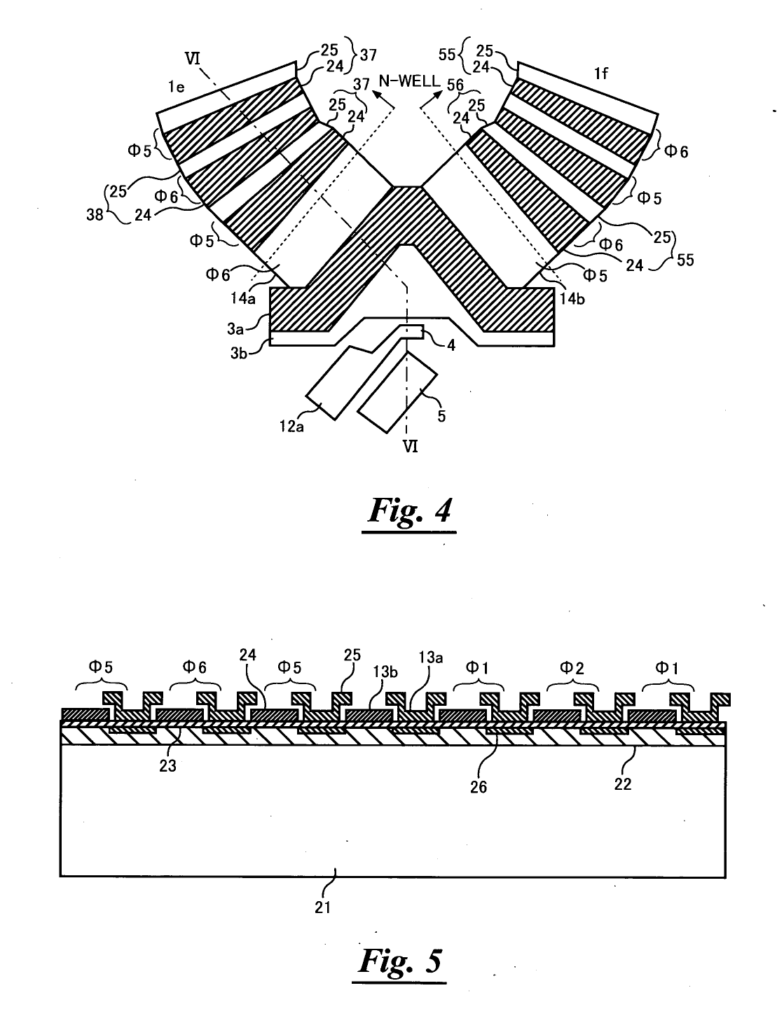

FIG. 2 is a magnified view of portion A of FIG. 1; FIG. 3 is a magnified view of portion B of FIG. 1; and FIG. 4 is a magnified view of portion C of FIG. 1.

As shown in FIGS. 2 through 4, the CCD 1a through 1f are each composed of a plurality of first polysilicon layer electrodes (first electrodes) 24 and second polysilicon layer electrodes (second electrodes) 25 arranged in alternating stages in the charge transfer direction.

In the present embodiment, a charge transfer device provided with two-phase-drive CCD 1a through 1f is described, and the CCD 1a through 1f are configured such that a charge is transferred by the application of first and second two-phase pulses that are in an inverse relationship to each other.

In this arrangement, CCD 1a and 1b constitute a two-phase-drive based on pulses φ1 and φ2 (see FIG. 7); CCD 1c and 1d constitute a two-phase-drive based on pulses φ3 and φ4 (see FIG. 7); and CCD 1e and 1f constitute a two-phase-drive based on pulses φ5 and φ6 (see FIG. 7).

As shown in FIG. 7, the pulses φ1, φ2, φ3, and φ4 have the same period. Pulse φ1 and pulse φ2 are inverted with respect to each other into high-level and low-level pulses; pulse φ3 and pulse φ4 are inverted with respect to each other into high-level and low-level pulses; and pulse φ5 and pulse φ6 are inverted with respect to each other into high-level and low-level pulses.

Pulse φ1 and pulse φ3 are out of phase with each other by a quarter period, and pulse φ2 and pulse φ4 are out of phase with each other by a quarter period.

Furthermore, the periods of pulse φ5 and pulse φ6 are half the periods of pulses φ1 through φ4.

More specifically, in the CCD 1a, the electrode pairs 33 and 34 composed of pairs of first polysilicon layer electrodes 24 and second polysilicon layer electrodes 25 adjacent to each other in the charge transfer direction are provided so as to be positioned in alternating fashion in the charge transfer direction. A configuration is adopted whereby pulse 41 is applied as the first pulse to the first polysilicon layer electrode 24 and second polysilicon layer electrode 25 contained in the electrode pair 34. At the same time, pulse φ2 is applied as the second pulse to the first polysilicon layer electrode 24 and second polysilicon layer electrode 25 contained in the electrode pair 33.

In the same manner, in the CCD 1b, the electrode pairs 35 and 36 composed of pairs of first polysilicon layer electrodes 24 and second polysilicon layer electrodes 25 adjacent to each other in the charge transfer direction are provided so as to be positioned in alternating fashion in the charge transfer direction. A configuration is adopted whereby pulse φ2 is applied as the second pulse to the first polysilicon layer electrode 24 and second polysilicon layer electrode 25 contained in the electrode pair 36. At the same time, pulse φ1 is applied as the first pulse to the first polysilicon layer electrode 24 and second polysilicon layer electrode 25 contained in the electrode pair 35.

In other words, pulse φ1, for example, is applied as the first pulse to the electrode pair 34 positioned furthest downstream of CCD 1a, which is one of the two mutually merged devices CCD 1a and CCD 1b, and pulse φ2 is applied as the second pulse to the electrode pair 36 positioned furthest downstream of the other CCD 1b.

In the same manner, in the CCD 1c, the electrode pairs 51 and 52 composed of pairs of first polysilicon layer electrodes 24 and second polysilicon layer electrodes 25 adjacent to each other in the charge transfer direction are provided so as to be positioned in alternating fashion in the charge transfer direction. A configuration is adopted whereby pulse φ3 is applied as the first pulse to the first polysilicon layer electrode 24 and second polysilicon layer electrode 25 contained in the electrode pair 52. At the same time, pulse φ4 is applied as the second pulse to the first polysilicon layer electrode 24 and second polysilicon layer electrode 25 contained in the electrode pair 51.

In the same manner, in the CCD 1d, the electrode pairs 53 and 54 composed of pairs of first polysilicon layer electrodes 24 and second polysilicon layer electrodes 25 adjacent to each other in the charge transfer direction are provided so as to be positioned in alternating fashion in the charge transfer direction. A configuration is adopted whereby pulse φ4 is applied as the second pulse to the first polysilicon layer electrode 24 and second polysilicon layer electrode 25 contained in the electrode pair 54. At the same time, pulse φ3 is applied as the first pulse to the first polysilicon layer electrode 24 and second polysilicon layer electrode 25 contained in the electrode pair 53.

In other words, pulse φ3 is applied as the first pulse to the electrode pair 52 positioned furthest downstream of CCD 1c, which is one of the two mutually merged devices CCD 1c and CCD 1d, and pulse φ4 is applied as the second pulse to the electrode pair 54 positioned furthest downstream of the other CCD 1d.

The phases of the first and second pulses are offset by a quarter period from each other in the pulses applied to CCD 1a (first charge transfer register) and CCD 1b (second charge transfer register), and in the pulses applied to CCD 1c (third charge transfer register) and CCD 1d (fourth charge transfer register). In other words, as described above, pulse φ1 and pulse φ3 are out of phase with each other by a quarter period, and pulse φ2 and pulse φ4 are out of phase with each other by a quarter period.

Pulses φ1 through φ4 are generated by a pulse generation means not shown in the diagram, and are applied to the electrodes 24 and 25.

As shown in FIG. 2 and FIG. 4, in the CCD 1e, the electrode pairs 37 and 38 composed of pairs of first polysilicon layer electrodes 24 and second polysilicon layer electrodes 25 adjacent to each other in the charge transfer direction are provided so as to be positioned in alternating fashion in the charge transfer direction. A configuration is adopted whereby pulse φ5 is applied as the first pulse to the first polysilicon layer electrode 24 and second polysilicon layer electrode 25 contained in the electrode pair 37. At the same time, pulse φ6 is applied as the second pulse to the first polysilicon layer electrode 24 and second polysilicon layer electrode 25 contained in the electrode pair 38.

In the same manner, in the CCD 1f, as shown in FIG. 3 and FIG. 4, the electrode pairs 55 and 56 composed of pairs of first polysilicon layer electrodes 24 and second polysilicon layer electrodes 25 adjacent to each other in the charge transfer direction are provided so as to be positioned in alternating fashion in the charge transfer direction. A configuration is adopted whereby pulse φ5 is applied as the first pulse to the first polysilicon layer electrode 24 and second polysilicon layer electrode 25 contained in the electrode pair 56. At the same time, pulse φ6 is applied as the second pulse to the first polysilicon layer electrode 24 and second polysilicon layer electrode 25 contained in the electrode pair 55.

As shown in FIG. 4, in the last two CCD 1e and CCD 1f, the second polysilicon layer electrodes 25 adjacent to the output gate 3a are not part of an electrode pair, and these electrodes are particularly referred to as the final transfer electrodes 14a and 14b.

Among the final two CCD 1e and CCD 1f, pulse φ6 is applied as the second pulse to the final transfer electrode 14a of the single CCD 1e, and pulse φ5 is applied as the first pulse to the final transfer electrode 14b of the other CCD 1f.

The pulses φ5 and φ6 applied to the final two CCD 1e and CCD 1f are set to half the period of the pulses applied to the CCD 1a through 1d of the previous stage.

In the case of the present embodiment, a configuration is adopted, for example, whereby the pulses φ5 and φ6 applied to the CCD 1e and 1f of the next stage are generated based on the pulses φ1 through φ4 applied to the CCD 1a through 1d of the previous stage.

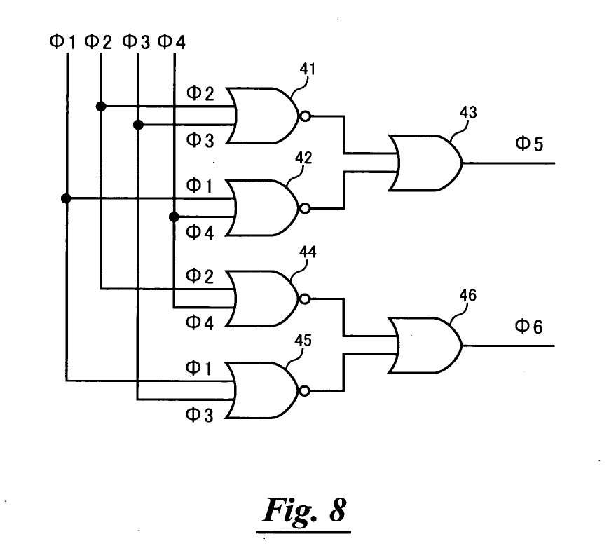

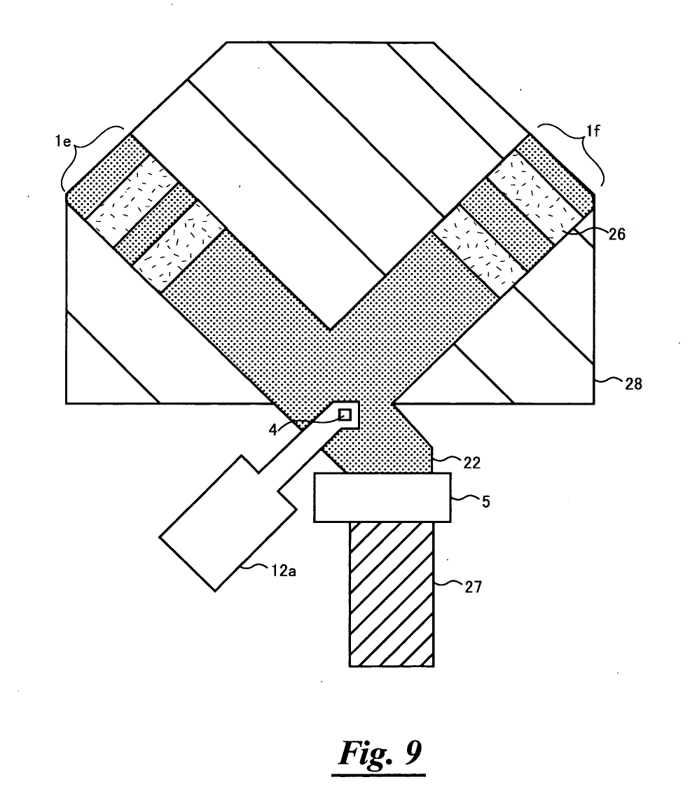

FIG. 8 is a circuit diagram showing an example of the logic circuit for generating pulses φ5 and φ6 using pulses φ1 through φ4.

The logic circuit shown in FIG. 8 is provided with a first AND circuit 41 to which pulse φ2 and pulse φ3 are inputted; a second AND circuit 42 to which pulse φ1 and pulse φ4 are inputted; a third AND circuit 43 to which the outputs from the first AND circuit 41 and second AND circuit 42 are inputted together; a fourth AND circuit 44 to which pulse φ2 and pulse φ4 are inputted; a fifth AND circuit 45 to which pulse φ1 and pulse φ3 are inputted; and a sixth AND circuit 46 to which the outputs from the fourth AND circuit 44 and fifth AND circuit 45 are inputted together. Therefore, the third AND circuit 43 outputs pulse φ5, and the sixth AND circuit 46 outputs pulse φ6.

By using this type of logic circuit, pulse φ5 is the pulse generated when the pulse φ2 applied to the CCD 1a and the CCD 1b, and the pulse φ3 applied to the CCD 1c and the CCD 1d are both high level, and when the pulse φ1 applied to the CCD 1a and the CCD 1b, and the pulse φ4 applied to the CCD 1c and the CCD 1d are both high level. Specifically, pulse φ5 can be used as the first pulse applied to CCD 1e, which is one of the final two CCD, and as the second pulse applied to CCD 1f, which is the other of the final two CCD. Also, pulse φ6 is the pulse generated when the pulse 2 applied to the CCD 1a and the CCD 1b, and the pulse φ4 applied to the CCD 1c and the CCD 1d are both high level, and when the pulse φ1 applied to the CCD 1a and the CCD 1b, and the pulse φ3 applied to the CCD 1c and the CCD 1d are both high level. Specifically, pulse φ6, can be used as the second pulse applied to CCD 1e, which is one of the final two CCD, and as the first pulse applied to CCD 1f, which is the other of the final two CCD.

A more specific description of the shape of the electrodes will next be given.

As shown in FIG. 2, in the portion that extends from the point downstream in the charge transfer direction of the two mutually merged CCD 1a and 1b to the point upstream of the single CCD 1e after the CCD 1a and 1b are merged, the first polysilicon layer electrodes 24 and second polysilicon layer electrodes 25 in each stage in the charge transfer direction are symmetric about the centerline between the two merged CCD 1a and 1b.

Specifically, the two mutually merged CCD 1a and 1b and the single merged CCD 1e form a substantial Y-shape, for example.

The second polysilicon layer electrodes 25 in each stage are formed so that the width thereof in the charge transfer direction is substantially constant along the direction that intersects the transfer direction.

Furthermore, in the portion that extends from the point downstream in the charge transfer direction of the two mutually merged CCD 1a and 1b to the point upstream of the single merged CCD 1e, the first polysilicon layer electrodes 24 in each stage are formed so as to gradually widen towards the centerline between the two merged charge transfer registers, and also so as to gradually narrow away from the centerline. In addition, the wide portions on the side of the aforementioned centerline of the first polysilicon layer electrodes 24 in each stage are formed so as to gradually narrow towards the downstream side in the charge transfer direction.

In the same manner, as shown in FIG. 3, in the portion that extends from the point downstream in the charge transfer direction of the two mutually merged CCD 1a and 1b to the point upstream of the single CCD 1e after the CCD 1a and 1b are merged, the first polysilicon layer electrodes 24 and second polysilicon layer electrodes 25 arranged in each stage in the charge transfer direction are symmetric about the centerline between the two merged CCD 1a and 1b.

Specifically, the two mutually merged CCD 1a and 1b and the single merged CCD 1e form a substantial Y-shape, for example.

Furthermore, in the portion extending from the point downstream in the charge transfer direction of the two mutually merged CCD 1a and 1b to the point upstream of the merged single CCD 1e, the first polysilicon layer electrodes 24 in each stage are formed so as to gradually widen towards the centerline between the two merged charge transfer registers, and also so as to gradually narrow away from the centerline. In addition, the wide portion on the side of the aforementioned centerline in the first polysilicon layer electrodes 24 in each stage are designed so as to gradually narrow towards the downstream side of the charge transfer direction.

Since the electrodes have the type of shape described above, the width in the charge transfer direction of the second polysilicon layer electrodes 25 in each stage can easily be narrowed while a substantially constant width is maintained along the direction that intersects the transfer direction when the two CCD 1a and 1b are narrowed into one CCD 1e, and also when the two CCD 1c and 1d are narrowed into the single CCD 1f.

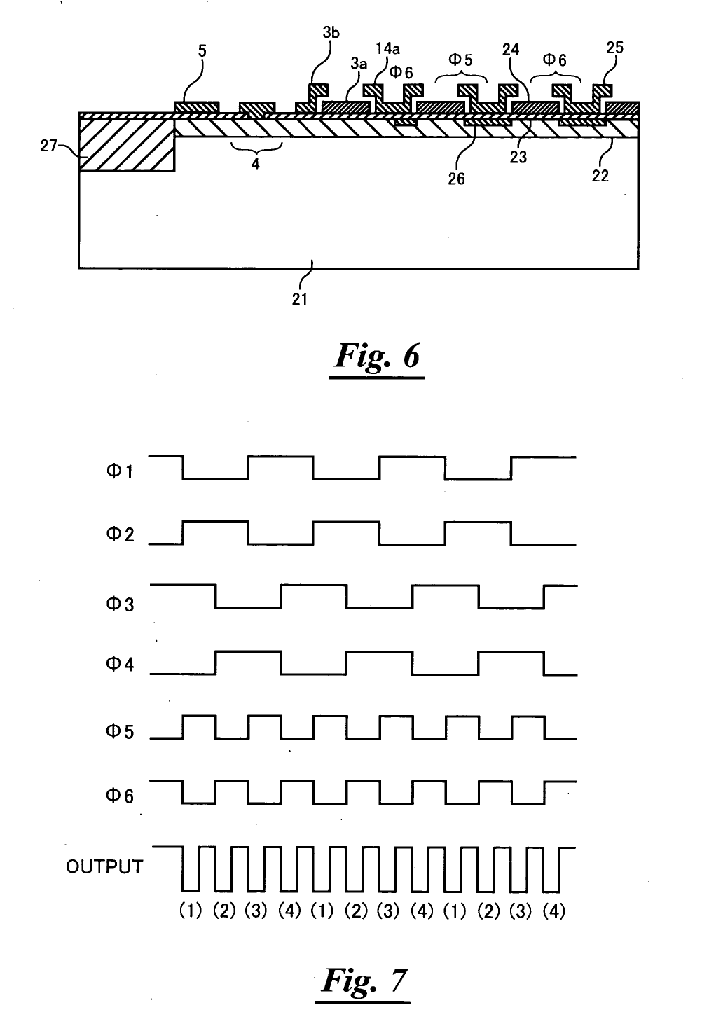

FIG. 5 is a diagram showing the cross-sectional structure along line X-X′ of FIG. 2; and FIG. 6 is a diagram showing the cross-sectional structure along line Y-Y′ of FIG. 4.

As shown in FIG. 5, an N-well 22 is formed on one principal surface of the P-substrate 21, and the first polysilicon layer electrodes 24 and second polysilicon layer electrodes 25 are formed on the N-well 22 so as to be arranged in alternating fashion.

Boron is implanted in the gap of the first polysilicon layer electrode 24, and an N-negative well 26 is formed in the top layer portion of the N-well 22. The first polysilicon layer electrode 24 thereby becomes a storage electrode for accumulating a charge, and the second polysilicon layer electrode 25 becomes a barrier electrode.

As shown in FIG. 6, an N-negative well 26 is formed by localized barrier boron implantation in a portion of the top layer of the N-well 22 positioned below the final transfer electrode 14a, and a storage area and a barrier area exist below one electrode (one final transfer electrode 14a).

The gate electrode of the MOS transistor 12a of the source follower amplifier 7 formed by the second polysilicon layer electrode 25 is connected to the charge detection unit 4. The drain 6 adjacent to the reset gate 5 is composed of the N-positive diffusion layer 27.

Operation will next be described.

In FIG. 1, the arrows pointing towards the CCD 1a through 1d from the photodiodes contained in the photodiode rows 2a and 2b indicate the read direction of charges from each of the photodiodes to the CCD 1a through 1d, and the charges are transferred to different CCD in alternating fashion. In other words, a charge is transferred to the CCD 1b from the photodiode on one end in the photodiode row 2a, a charge is transferred to the CCD 1a from the adjacent photodiode, a charge is transferred to the CCD 1b from the next adjacent photodiode, and so forth, with charges being transferred from the photodiodes to the corresponding (in other words, to the connected) CCD.

Charges transferred via the CCD 1a and the CCD 1b are transferred to the CCD 1e in alternating fashion via the transfer gates 13a and 13b. Specifically, when pulse φ1 is low level, and pulse φ5 is high level, a charge is transferred from the CCD 1a to the CCD 1e. When pulse φ2 is low level, and pulse φ5 is high level, a charge is transferred from the CCD 1b to the CCD 1e.

In the same manner, charges transferred via the CCD 1c and the CCD 1d are transferred to the CCD 1f in alternating fashion via the transfer gates 13a and 13b.

Specifically, when pulse φ3 is low level, and pulse φ6 is high level, a charge is transferred from the CCD 1c to the CCD 1f. When pulse φ4 is low level, and pulse φ6 is high level, a charge is transferred from the CCD 1d to the CCD 1f.

The transfer gates 13a and 13b are presented with a DC voltage at which the channel potential at the bottom of the transfer gate 13b is higher than at the bottom of the transfer gate 13a among the channel potentials at the bottoms of the transfer gates 13a and 13b.

Charges transferred via the CCD 1e and the CCD 1f are transferred to the charge detection unit 4 in alternating fashion via the output gates 3a and 3b.

Specifically, when pulse φ6 is low level, a charge is transferred from the CCD 1e to the charge detection unit 4, and when pulse φ5 is low level, a charge is transferred from the CCD if to the charge detection unit 4.

The output gates 3a and 3b are presented with a DC voltage at which the channel potential at the bottom of the output gate 3b is higher than at the bottom of the output gate 3a among the channel potentials at the bottoms of the output gates 3a and 3b.

As a result, a signal charge is outputted in the following sequence: CCD 1b→CCD 1d→CCD 1a→CCD 1c. The signal charge transferred to the charge detection unit 4 is converted to a voltage, and is outputted via the source follower amplifier 7. After charge detection, the charge detection unit 4 is reset to the potential of the drain 6 by a reset pulse being applied to the reset gate 5.

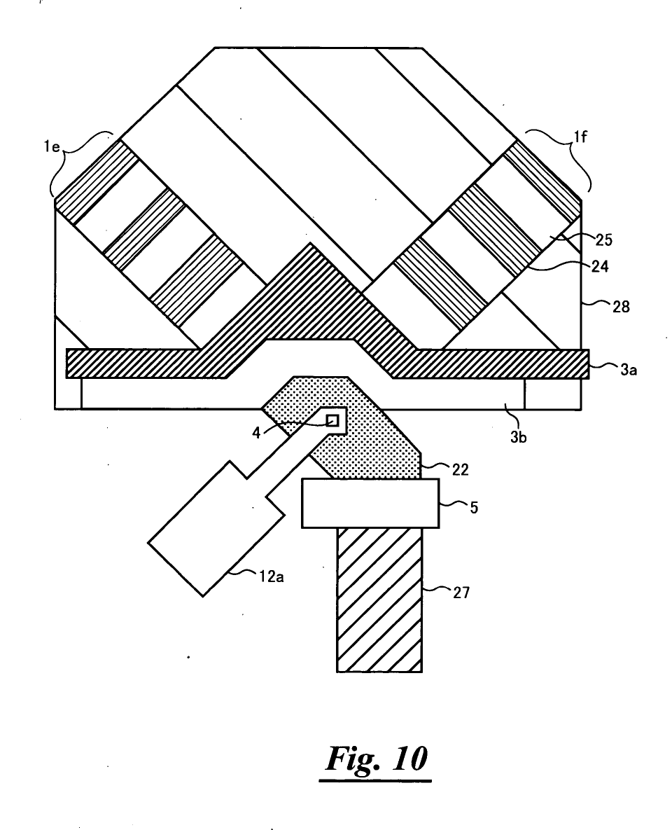

FIG. 9 is a partial magnified view showing the bottom portion of the electrode near the charge detection unit in the charge transfer device according to the present embodiment; and FIG. 10 is a partial magnified view showing the positioning of the electrode near the charge detection unit in the charge transfer device according to the present embodiment.

As shown in FIG. 9 and FIG. 10, in the present embodiment, the four CCD 1a through 1d are merged into the two CCD 1e and 1f, and the final two CCD 1e and 1f are merged and connected to the charge detection unit 4. Therefore, the symmetry is good in comparison with the conventional example, and it becomes possible to make the shapes of the CCD transfer channels substantially identical. Specifically, to merge the various CCD, it is possible to use substantially the same shapes for the transfer channels of CCD 1a and CCD 1b, the transfer channels of CCD 1c and CCD 1d, the transfer channels of CCD 1a/CCD 1b and CCD 1c/CCD 1d, and the transfer channels of CCD 1e and CCD 1f. Narrowing can be performed easily and with good symmetry. Therefore, fluctuation in the efficiency of transfer between CCD can be minimized, and a charge transfer device having good transfer efficiency can be obtained.

Since a charge transfer device can be obtained using half the number of channels compared to the conventional example, extra space appears in the layout area, and even if a channel separation area for preventing charge mixing is formed between CCD, sudden narrowing in the CCD channel width such as that shown in FIG. 18 can be avoided. There is therefore no occurrence of transfer degradation due to the pattern structure.

### Second Embodiment

An example will be described as a second embodiment wherein pulses φ1 through φ4 are set to 5 V, and pulses φ5 and φ6 are set to voltage pulses that are higher than pulses φ1 through φ4 in the charge transfer device described in the first embodiment above.

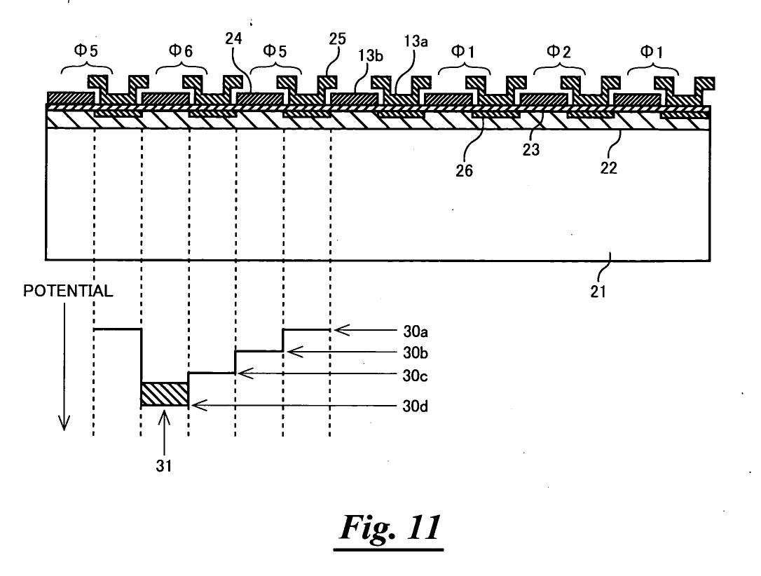

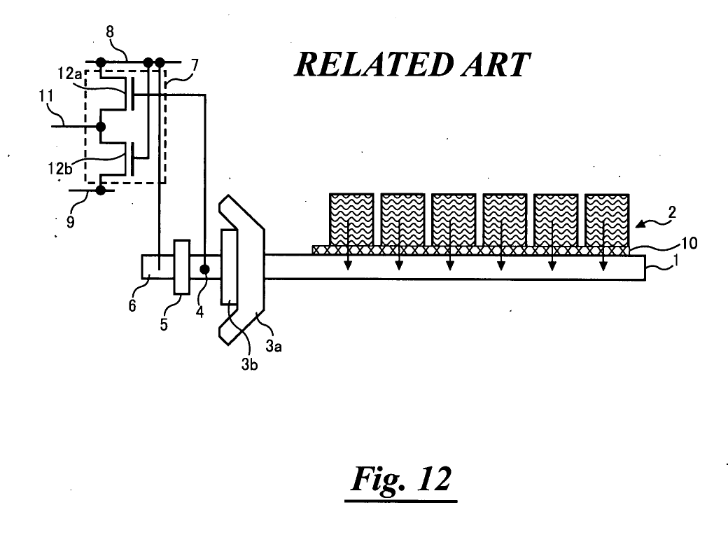

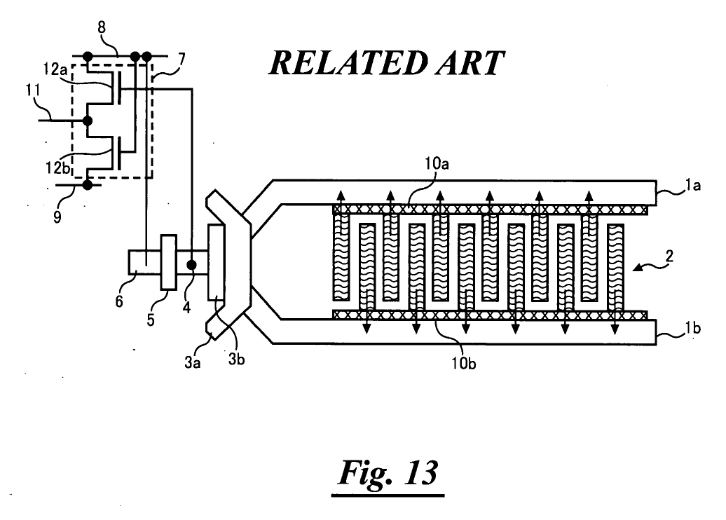

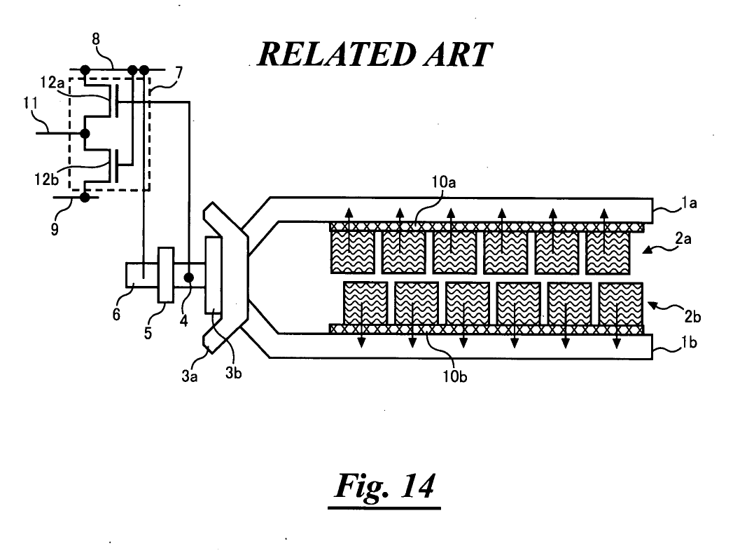

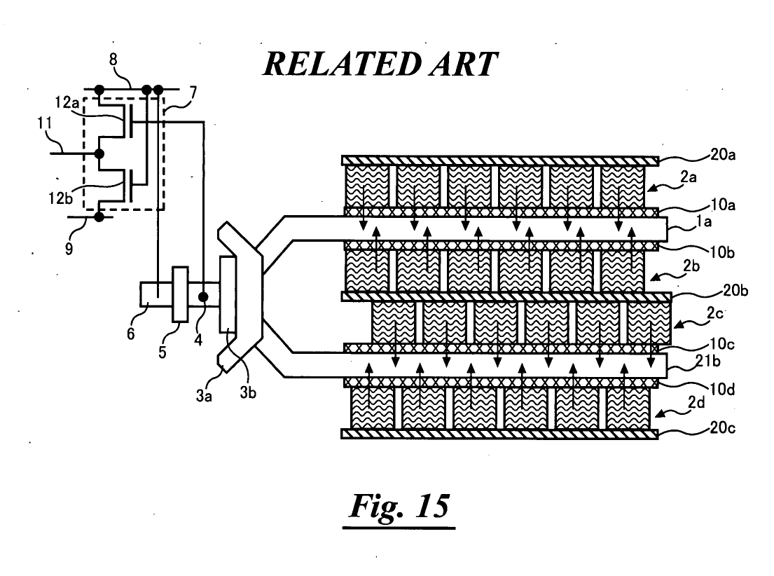

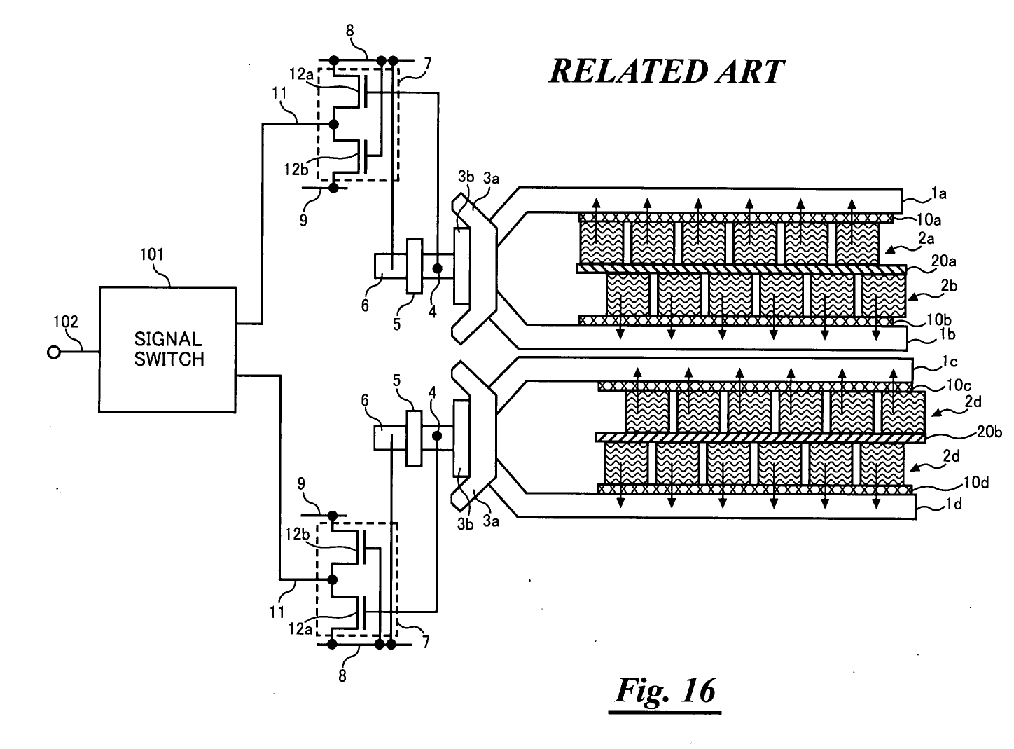

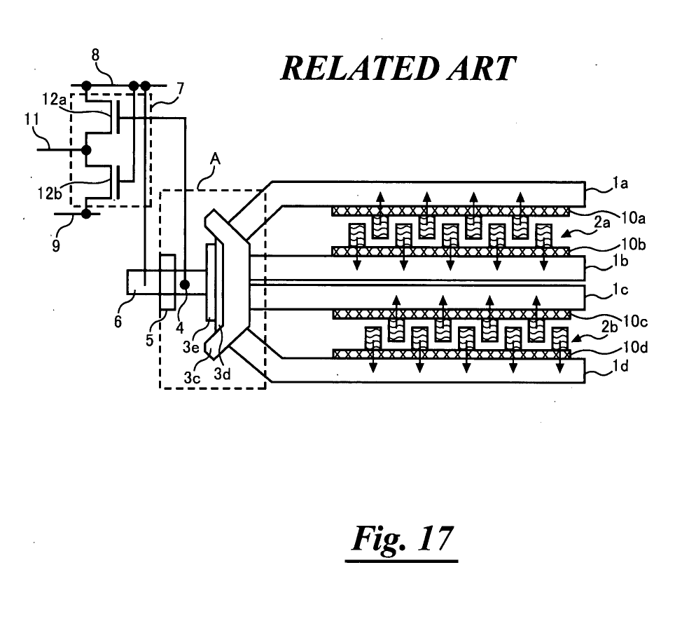

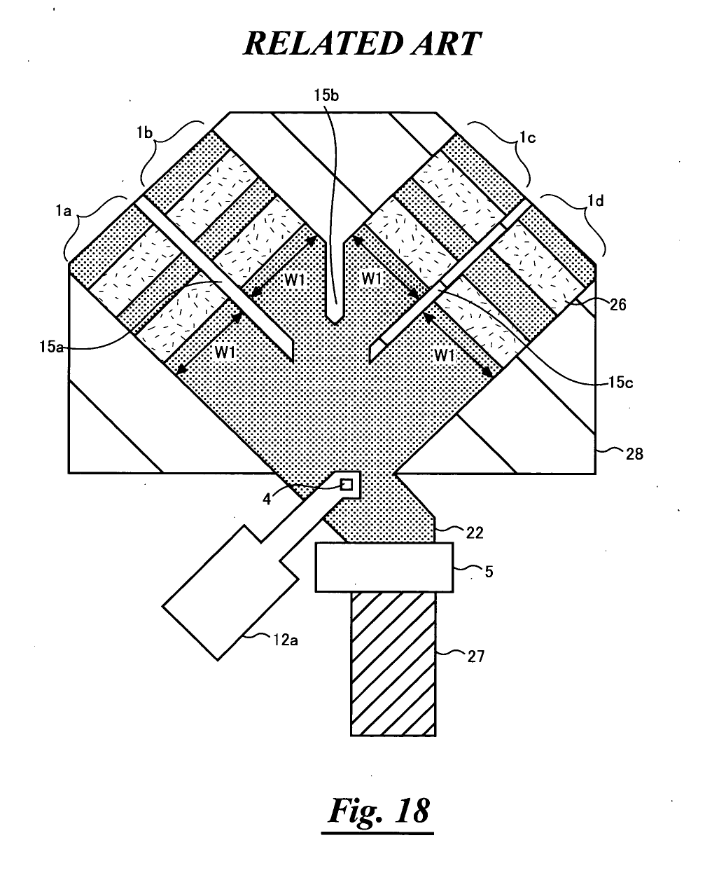

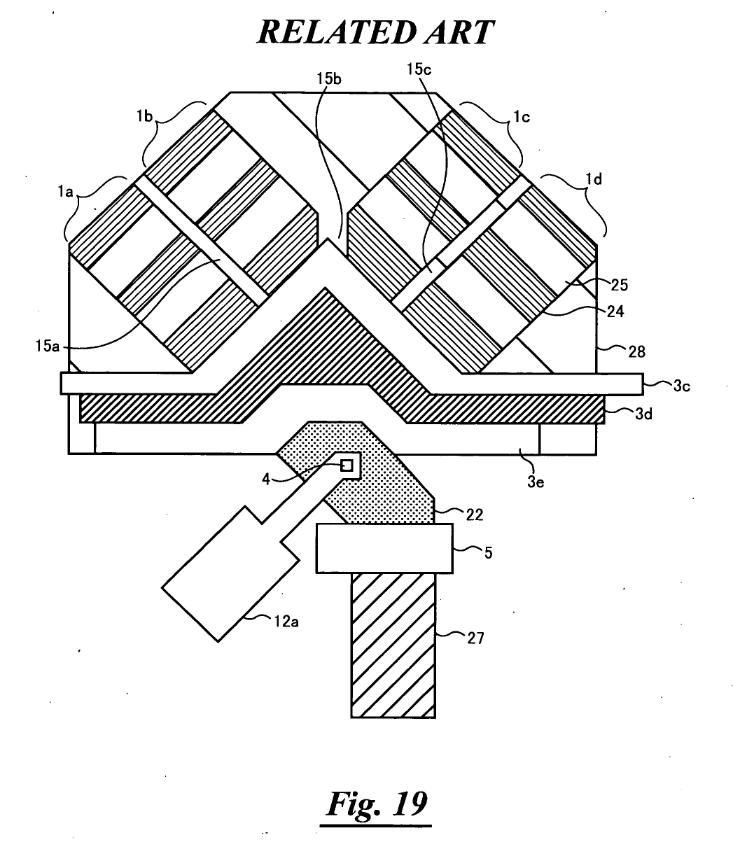

FIG. 11 is a cross-sectional view along line X-X′ of FIG. 2 in the case of the charge transfer device according to the second embodiment.

The pulses φ5 and φ6 (the voltage pulses that are higher than pulses φ1 through φ4) are increased in voltage and generated as described below using the circuit in FIG. 8.

Specifically, the lower part of the electrodes for generating pulses φ1 through φ4 is designated as the first N-negative well (corresponding to the N-negative well 26 shown in FIG. 5 and FIG. 6), while the lower part of the electrodes for generating pulses φ5 and φ6 is designated as the second N-negative well 29. It is thereby possible to vary the potential difference under the first and second polysilicon layer electrodes 24 and 25 for the pulses φ5 and φ6 independently from the pulses φ1 through φ4.

A potential diagram is shown at the bottom of FIG. 11. FIG. 11 shows a case in which pulse φ5 is low level, and pulse φ6 is high level. The difference between the first potential (potential 1) 30a and the second potential (potential 2) 30b, and the difference between the third potential (potential 3) 30c and the fourth potential (potential 4) 30d are adjusted by the concentration of the second N-negative well 29, and the difference between the first potential 30a and the third potential 30c, or the difference between the second potential 30b and the fourth potential 30d, is adjusted by the voltage value of pulse φ6.

By the combination of making the voltage of pulse φ6 higher than 5 V and increasing the injection concentration of the second N-negative well 29, the amount of charge accumulated by the charge accumulating portion 31 in FIG. 11 is increased in comparison with the side on which pulses φ1 through φ4 are generated.

When the same amount of charge is transferred as in the case of the above-mentioned first embodiment, the charge transfer channel width of pulses φ5 and φ6 can thereby be narrowed and less space can be used by the second embodiment in comparison with the first embodiment.

As described above, by the second embodiment, the same effects are obtained as in the abovementioned first embodiment, the charge transfer channel width of pulses φ5 and φ6 can additionally be narrowed, and less space can be used by the second embodiment in comparison with the first embodiment.

It is apparent that the present invention is not limited to the above embodiment and it may be modified and changed without departing from the scope and spirit of the invention.

1. A charge transfer device comprising:
4n (where n is a positive integer) initial-stage charge transfer registers to which a plurality of photoelectric converters is connected; and
a charge detection unit detecting a charge transferred from the initial-stage charge transfer registers in sequence via a secondary-stage charge transfer register; wherein
the merging of two charge transfer registers adjacent to each other among the initial-stage charge transfer registers into one charge transfer register disposed in the secondary stage is repeated at least once, and the final two charge transfer registers after merging are connected to one charge detection unit.

2. A charge transfer device comprising:
a plurality of initial-stage charge transfer registers, each being connected to a plurality of photoelectric converters;
a secondary-stage charge transfer register coupled to at least two initial-stage charge transfer registers; and
a charge detection unit coupled to the secondary-stage charge transfer register.

3. The charge transfer device according to claim 1, wherein the charge transfer registers provided in the charge transfer device are each provided with a plurality of first electrodes and second electrodes arranged in alternating fashion in the charge transfer direction, and are configured such that a charge is transferred by the application of first and second two-phase pulses that are in an inverse relationship to each other; and
the electrode pairs comprising the first and second electrodes adjacent to each other in the transfer direction are provided such that first electrode pairs to which the first pulse is applied and second electrode pairs to which the second pulse is applied are arranged in alternating fashion.

4. The charge transfer device according to claim 3, comprising:
a first AND circuit to which the second pulse applied to the first and second charge transfer registers is inputted together with the first pulse applied to the third and fourth charge transfer registers;
a second AND circuit to which the first pulse applied to the first and second charge transfer registers is inputted together with the second pulse applied to the third and fourth charge transfer registers;
a third AND circuit to which the outputs from the first and second AND circuits are inputted;
a fourth AND circuit to which the second pulse applied to the first and second charge transfer registers is inputted together with the second pulse applied to the third and fourth charge transfer registers;
a fifth AND circuit to which the first pulse applied to the first and second charge transfer registers is inputted together with the first pulse applied to the third and fourth charge transfer registers; and
a sixth AND circuit to which the outputs from the fourth and fifth AND circuits are inputted.

5. The charge transfer device according to claim 3, wherein the pulse applied to the charge transfer register of the next stage is generated based on the pulse applied to the charge transfer register of the previous stage.

6. The charge transfer device according to claim 3, wherein a pulse having a higher voltage than the pulse applied to the charge transfer register of the previous stage is used as the pulse applied to the charge transfer register of the next stage.

7. The charge transfer device according to claim 1, wherein the charge transfer registers provided in the charge transfer device are each provided with a plurality of first electrodes and second electrodes arranged in alternating fashion in the charge transfer direction.

8. The charge transfer device according to claim 7, wherein
in the portion extending from the point downstream in the charge transfer direction of the two mutually merged charge transfer registers to the point upstream of the single merged charge transfer register, the first electrode in each stage and second electrode in each stage in the charge transfer direction are symmetric about the centerline between the two merged charge transfer registers.

9. The charge transfer device according to claim 8, wherein the two mutually merged charge transfer registers and the single merged charge transfer register form a substantial Y-shape.

10. The charge transfer device according to claim 7, wherein the second electrode in each stage is formed so as to have a width in the charge transfer direction that is substantially constant along the direction that intersects the transfer direction.

11. The charge transfer device according to claim 10, wherein
in the portion extending from the point downstream in the charge transfer direction of the two mutually merged charge transfer registers to the point upstream of the single merged charge transfer register, the first electrode in each stage is formed so as to gradually widen towards the centerline between the two merged charge transfer registers, and also so as to gradually narrow away from the centerline.

12. The charge transfer device according to claim 11, wherein
in the portion extending from the point downstream in the charge transfer direction of the two mutually merged charge transfer registers to the point upstream of the single merged charge transfer register, the wide portion on the side of the centerline of the first electrode in each stage is formed so as to gradually narrow towards the downstream side in the charge transfer direction.

13. A method for driving the charge transfer device according to claim 3, comprising transferring a charge by applying first and second two-phase pulses in an inverse relationship to each other to the charge transfer registers.

14. The drive method for a charge transfer device according to claim 13, comprising applying the first pulse to the electrode pair positioned furthest downstream of the one charge transfer register among the two mutually merged charge transfer registers, and applying the second pulse to the electrode pair positioned furthest downstream of the other charge transfer register.

15. The drive method for a charge transfer device according to claim 14, wherein when the first and second charge transfer registers are merged into one of the final two charge transfer registers, and the third and fourth charge transfer registers are merged into the other of the final two charge transfer registers, the phases of the first pulses and the phases of the second pulses are offset by a quarter period from each other in the pulses applied to the first and second charge transfer registers, and in the pulses applied to the third and fourth charge transfer registers.

16. The drive method for a charge transfer device according to claim 15, wherein the pulses applied to the final two charge transfer registers are set to half the period of the pulses applied to the first through fourth charge transfer registers.

17. The drive method for a charge transfer device according to claim 16, wherein when the second pulse applied to the first and second charge transfer registers and the first pulse applied to the third and fourth charge transfer registers are both high level, and when the first pulse applied to the first and second charge transfer registers and the second pulse applied to the third and fourth charge transfer registers are both high level, the generated pulse is used as the first pulse applied to one of the final two charge transfer registers, and as the second pulse applied to the other of the final two charge transfer registers; and wherein
when the second pulse applied to the first and second charge transfer registers and the second pulse applied to the third and fourth charge transfer registers are both high level, and when the first pulse applied to the first and second charge transfer registers and the first pulse applied to the third and fourth charge transfer registers are both high level, the generated pulse is used as the second pulse applied to one of the final two charge transfer registers, and as the first pulse applied to the other of the final two charge transfer registers.

18. A method for driving the charge transfer device according to claim 1, comprising generating the pulse applied to the charge transfer register of the next stage on the basis of the pulse applied to the charge transfer register of the previous stage.
